(19) United States
(12) Patent Application Publication
(10) Pub. No.: US 2024/0105967 A1
(43) Pub. Date: Mar. 28, 2024

(54) BIPOLAR PLATE FOR FUEL CELL STACK

(71) Applicant: L'Air Liquide, Societe Anonyme pour l'Etude et l’Exploitation des Procedes Georges Claude, Paris (FR)

(72) Inventors: Johan ANDRE, Sanssenage (FR); Camille BOUVIER, Sassenage (FR); Eric CLAUDE, Sassenage (FR); Nicolas JANNIN, Sassenage (FR); Denis SIRAC, Sassenage (FR); Didier ZAEPFFEL, Sassenage (FR)

(73) Assignee: L'Air Liquide, Societe Anonyme pour l'Etude et l’Exploitation des Procedes Georges Claude, Paris (FR)

(21) Appl. No.: 18/513,486

(22) Filed: Nov. 17, 2023

Related U.S. Application Data
(63) Continuation of application No. 17/035,626, filed on Sep. 28, 2020.

(30) Foreign Application Priority Data
Oct. 18, 2019 (FR) FR 1911717

(51) Int. Cl. H01M 8/026; H01M 8/2484

(52) U.S. Cl. CPC H01M 8/026; H01M 8/2484; H01M 2008/1095

(57) ABSTRACT

The invention relates to a bipolar plate for a fuel cell stack that extends in a vertical plane in the use position, the plate comprising opposed first and second transverse edges, upper and lower longitudinal edges, a central region arranged between the edges, a first opening for a heat transfer fluid inlet, a second opening for heat transfer fluid collection a third opening for an oxidant inlet, a fourth opening for oxidant collection, a fifth opening for the inlet of a fuel, a sixth opening for fuel collection, wherein the first, third and sixth openings are arranged in the first transverse edge and are arranged axially in relation to one another, the second, fourth and fifth openings are arranged in the second transverse edge and are arranged axially in relation to one another, and, in the vertical position of use of the plate: the sixth opening are arranged below the first and third openings, the fourth opening is arranged below the second and fifth openings, and the second opening is arranged above the fourth and fifth openings.

### CROSS-REFERENCE TO RELATED APPLICATIONS

This application is a continuation of U.S. patent application Ser. No. 17/035,626, filed Sep. 28, 2020, which claims the benefit of priority under 35 U.S.C. § 119 (a) and (b) to French patent application No. FR 1911717, filed Oct. 18, 2019, the entire contents of which are incorporated herein by reference.

### BACKGROUND

### Field of the Invention

The present invention pertains to a bipolar plate for a fuel cell stack, a cell for a fuel cell stack comprising such a plate and to a fuel cell stack comprising such a cell. The invention is particularly advantageously, but not exclusively, applicable to fuel cell stacks whose cells comprise bipolar plates that extend in a vertical plane when the stack is in the position of use.

### RELATED ART

In a manner known per se, a fuel cell stack is an electrochemical device that allows chemical energy to be converted into electrical energy using a fuel, generally dihydrogen, and an oxidant, generally dioxygen or a gas containing same such as air, the product of the reaction being water together with a release of heat and production of electricity. A fuel cell stack may for example be used to drive a motor vehicle by supplying the electrical devices contained in a vehicle with power.

A fuel cell stack may consist of one or more cells. With reference to FIG. 1 which shows a cell 1 for a fuel cell stack of the prior art, such a cell 1 comprises a proton-conducting electrolyte 2 which is sandwiched between two porous cathode 3 and anode 4 electrodes and which provides proton transfer between these two electrodes 3, 4.

To this end, the electrolyte 2 may be a polymer proton exchange membrane in particular with a thickness of between 20 and 200 μm, the resulting stack being a PEM (for “proton exchange membrane”) or PEMFC (for “proton exchange membrane fuel cell”) stack.

The assembly made up of the electrolyte 2 and the two electrodes 3, 4 forms a membrane electrode assembly (MEA) 5 which is itself sandwiched between first 6 and second 7 bipolar plates which collect current, distribute the oxidant and the fuel to the electrodes 3, 4 and circulate heat transfer fluid.

The bipolar plates 6, 7 that are typically used are made of materials that provide good corrosion resistance and electrical conductivity properties, like carbon-based materials such as graphite, polymer-impregnated graphite or flexible graphite sheets shaped by machining or by moulding.

It is also possible, to produce the bipolar plates 6, 7, to use metal materials such as alloys based on titanium, on aluminium and on iron, including stainless steels. In this case, the shaping of the bipolar plate may be achieved by pressing or stamping sheets of low thickness.

In order to ensure that the oxidant, the fuel and the heat transfer fluid are distributed to all of the cells making up the stack, the second bipolar plate 7 comprises six openings 7a, 7b, 7c, 7d, 7e, 7f, three of which 7a, 7b, 7c are arranged on the upper edge 8 of this plate 7, the three other openings 7d, 7e, 7f being, in a symmetrical manner, arranged on the lower edge 9 of this plate 7.

The first bipolar plate 6 comprises the same openings arranged in the same places as on the bipolar plate 7, despite FIG. 1 showing only the three upper openings 6a, 6b, 6c and one lower opening 6d.

The openings 6a, 6b, 6c, 6d of the first bipolar plate 6 and the openings 7a, 7b, 7c, 7d, 7e, 7f of the second bipolar plate 7 are aligned to form thereby manifolds which allow the fluids to flow through all of the cells making up the stack.

At each of these openings 7a, 7b, 7c, 7d, 7e, 7f, 6a, 6b, 6c, 6d, a duct (not shown) makes it possible to supply or collect the heat transfer fluid, the fuel or the oxidant flowing over the surface of the plate 6, 7 or through the plate 6, 7, or through fluid flow channels provided for this purpose.

With reference to FIG. 2 which is a section along the line II-II of FIG. 1, the cathode 3 and anode 4 electrodes each comprise a respective active layer 10, 11 which are the site of the cathode and anode reactions, respectively, and a respective diffusion layer 12, 13 inserted between the active layer 10, 11 and the corresponding bipolar plate 7, 6, this diffusion layer 12, 13 possibly being for example a paper substrate or a carbon fabric.

The diffusion layer 12, 13 allows the diffusion of the reactants such as dihydrogen and dioxygen which flow through the respective channels 14, 15 formed by grooves made in the respective bipolar plates 7, 6.

In this way, the active layer 11 of the anode electrode 4 is supplied with dihydrogen via the diffusion layer 13 and the reaction that takes place in this active layer 11 is the following: H₂→2e⁻+2H⁺. In the same way, the active layer 10 of the cathode electrode 3 is supplied with oxygen via the diffusion layer 12 and the reaction that takes place in this active layer 10 is the following: ½ O₂+2H++2e⁻→H₂O. These reactions are made possible by the presence of the membrane 2 which allows proton transfer from the active layer 11 of the anode 4 to the active layer 10 of the cathode 3.

In the case of the fuel cell stack being cooled by a liquid, in particular in the case of low-temperature fuel cell stacks (also called “LT-PEMs” for “low-temperature proton exchange membranes”), the bipolar plates extend in a vertical plane when the stack is in the position of use. It is important to ensure that the fluids circulate uniformly and to prevent both the accumulation of water in the manifolds and/or the channels which are located in the lower portion of the plates and the dissolved gases from being trapped in the manifolds and/or the channels which are located in the lower portion of the plates.

Additionally, the performance and service life of systems equipped with fuel cell stacks is largely dependent on the quality of the conveying of the reactants and the management of the water produced by the reaction. The distribution of the reactants needs to be as uniform as possible, the membrane electrode assembly needs to maintain a good level of hydration and, at the same time, the water needs to be removed as much as possible from the porosity of the electrodes precisely in order to allow the reactants to access the reaction sites. More specifically, it is necessary to reach a compromise between the drying-out of the proton conductor of the membrane at the gas inlet, and the flooding of the electrodes at the gas outlet.

### SUMMARY OF THE INVENTION

The present invention aims to efficiently overcome these drawbacks by providing a bipolar plate for a fuel cell stack, the plate extending in a vertical plane when the stack is in the position of use, in the vertical position of use, the plate comprising a first transverse edge, a second transverse edge opposite the first transverse edge, an upper longitudinal edge, a lower longitudinal edge, a central region arranged between the edges, a first opening for the inlet of a heat transfer fluid, a second opening for collecting the heat transfer fluid, a third opening for the inlet of an oxidant, in particular air, a fourth opening for collecting the oxidant, a fifth opening for the inlet of a fuel, in particular dihydrogen, a sixth opening for collecting the fuel, the first, third and sixth openings being arranged in the first transverse edge and being arranged axially in relation to one another, the second, fourth and fifth openings being arranged in the second transverse edge and being arranged axially in relation to one another, the plate comprising at least one distribution chamber, characterized in that in the vertical position of use of the plate:
the sixth opening is arranged below the first and third openings,
the fourth opening is arranged below the second and fifth openings,
the second opening is arranged above the fourth and fifth openings.

Because of the increase in temperature of the heat transfer fluid as it flows through the cell, at the inlet of the cathode, the excess air promotes a drying-out of the ionomer which partially constitutes the active layers of the membrane. Additionally, at the outlet of the cathode, the accumulated water produced promotes a flooding of the electrodes. The invention thus makes it possible, when the plate is in the vertical position of use, i.e. when the stack is in the horizontal position of use, to promote the removal of water and the degassing of the heat transfer fluid without compromising the uniformity of distribution of the fluids.

The particular positioning of the second opening allows gas bubbles trapped in the cooling circuit to escape naturally. Specifically, given the vertical position of the plate, the gas bubbles that form in this circuit are located in the upper portion of the distribution chamber and may thus escape via the second opening which is located at the same level.

Surprisingly, the advantage afforded by such an arrangement of the cooling circuit advantageously compensates for the imbalance in head losses caused by the lack of symmetry between the sixth and fifth openings.

According to one embodiment, in the vertical position of use of the plate, the third opening is arranged above the first and sixth openings.

Such a configuration makes it possible to prevent the flooding of the anode compartment by virtue of the relative disposition of the fuel collection, while the oxidant/fuel countercurrent and oxidant/heat transfer fluid co-current situation homogenizes the operating conditions of the cell through better water management.

According to one embodiment, the distribution chamber is arranged on the first transverse edge, on the surface of the plate, the distribution chamber extending in particular at least facing the third, first and sixth openings.

According to one embodiment, the distribution chamber is arranged on the second transverse edge, on the surface of the plate, the distribution chamber extending in particular at least facing the second, fifth and fourth openings.

This configuration makes it possible to balance the head losses (between the inlet and the collection) such that the distribution chamber does not need to be designed in a specific way to balance the fluid flow. Thus, the bulk of the plate and head loss are decreased.

According to one embodiment, the distribution chamber comprises protruding patterns, in particular bumps or lines of solder, to promote the uniformity of distribution of a fluid.

According to one embodiment, the plate comprises flow channels arranged in the central region, in particular on the surface of the plate, for example in the form of a corrugation of said surface.

According to one embodiment, the flow channels extend in the longitudinal axis of the plate.

Such a configuration makes it possible to decrease the bulk of the plate while retaining a good degree of uniformity in the distribution of the fluids.

According to one embodiment, each opening comprises a hole that passes through the thickness of the plate.

Another subject of the invention is a cell for a fuel cell stack, in particular for a proton exchange membrane fuel cell stack, comprising two bipolar plates such as described above and a membrane electrode assembly, the plates being arranged so as to cooperate together and in that the membrane electrode assembly is sandwiched between the plates.

According to one embodiment, the membrane electrode assembly is devoid of catalyst in the distribution chamber.

Another subject of the invention is a fuel cell stack, in particular a proton exchange membrane fuel cell stack, comprising at least one cell such as described above.

According to one embodiment, the stack comprises:
an inlet manifold for a heat transfer fluid that is intended to be connected to a heat transfer fluid intake to allow the fluid to flow through the first opening,
an inlet manifold for an oxidant that is intended to be connected to an oxidant intake to allow the oxidant to flow through the third opening, and
an inlet manifold for a fuel that is intended to be connected to a fuel intake to allow the fuel to flow through the fifth opening.

### BRIEF DESCRIPTION OF THE FIGURES

The invention will be understood better from reading the following description and from studying the accompanying figures. These figures are given only by way of illustration and do not in any way limit the invention.

FIG. 1 schematically shows a cell of the prior art;

FIG. 2 is a diagram along the axis II-II of FIG. 1; and

FIG. 3 is a front view of a bipolar plate for a cell according to the invention.

Those elements which are identical, similar or analogous keep the same reference from one figure to the next.

### DETAILED DESCRIPTION OF THE INVENTION

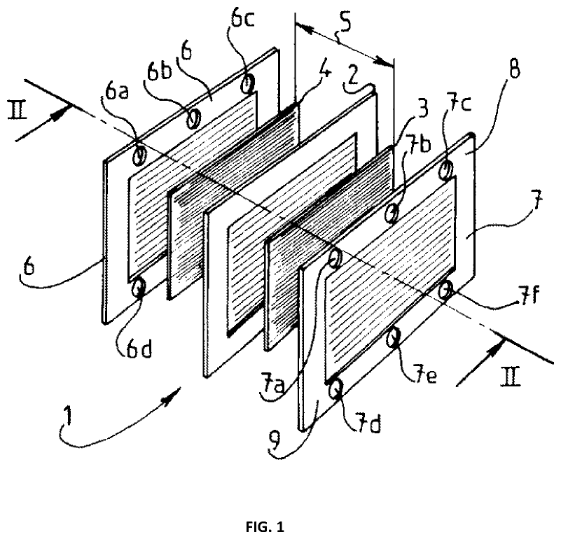

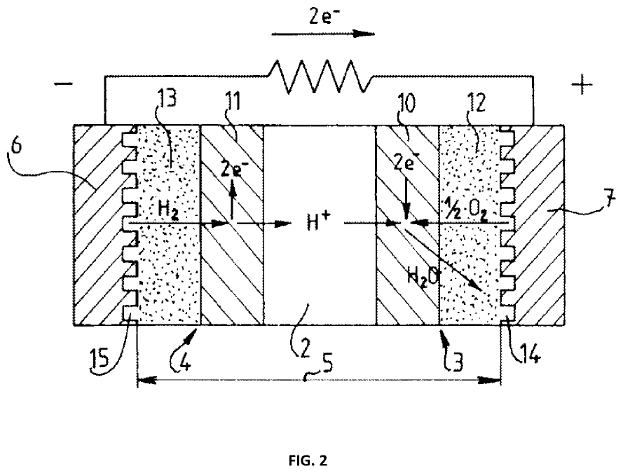

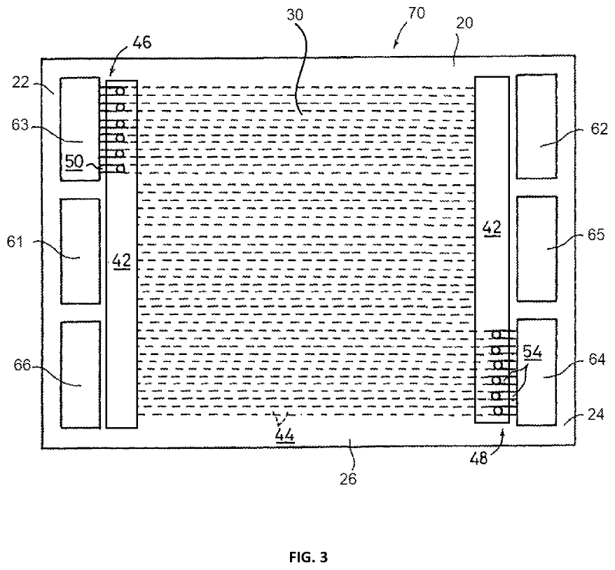

A cell for a fuel cell stack according to the invention is of the type described in conjunction with FIGS. 1 and 2. It comprises two bipolar plates 70 of the type shown in FIG. 3 and a membrane electrode assembly of the same type as that described with reference to FIGS. 1 and 2. The bipolar plates 70 are arranged so as to cooperate together such that the membrane electrode assembly is sandwiched between the plates 70.

A fuel cell stack according to the invention comprises a stack of cells such as those described above.

With reference to FIG. 3, the bipolar plate 70 of the invention is rectangular in shape in cross section. In one exemplary embodiment, its length is greater than about twice its width.

When the stack is in the position of use, the bipolar plate 70 extends in a vertical plane and it comprises a first transverse edge 22, a second transverse edge 24 opposite the first transverse edge 22, an upper longitudinal edge 20, a lower longitudinal edge 26, and a central region 30 arranged between the edges 20, 22, 24, 26.

The bipolar plate 70 comprises a third opening 63 for the inlet of an oxidant which is arranged in the first transverse edge 22.

Channels for the introduction 50 of the oxidant are produced in the plate 70 so as to allow the introduction of the oxidant from the third opening 63 into a chamber for the distribution of the oxidant 42 arranged in the plate 70 on the first transverse edge 22.

The chamber for the distribution of the oxidant 42 comprises bumps or lines of solder that make it possible to promote the uniformity of distribution of the oxidant thus introduced so as to make it flow through the central region 30, and more particularly to make it flow through the cathode electrode of the membrane electrode assembly which bears against one face of the bipolar plate 70. The distribution chamber 42 extends vertically over the entire height of the central region 30.

Flow channels 44 for the circulation of the oxidant are arranged in the central region 30, on the surface of the plate 70 and on one side thereof, so as to allow the oxidant to circulate. These flow channels 44 extend along the longitudinal axis of the plate 70 and open into another chamber for the distribution of the oxidant 42 which is located on the second transverse edge 24.

The bipolar plate 70 also comprises a fourth opening 64 for the collection of the oxidant which is arranged in the second transverse edge 24.

Channels for the collection 54 of the oxidant are produced in the plate 70 so as to allow the oxidant to be collected in the fourth opening 64 from the distribution chamber 42, which is located on the second transverse edge. These collection channels 54 thus make it possible to collect the oxidant that has flowed through the flow channels 44 and has been distributed by the distribution chamber 42.

In FIG. 3, just one face of the plate 70 is visible and on this face, the chambers for the distribution of the oxidant 42, the flow channels 44, the introduction channels 50 and the collection channels 54 are visible.

When the stack has been assembled, the third openings 63 for the inlet of the oxidant and the fourth openings 64 for the collection of the oxidant of all of the plates are superposed and form a manifold that conveys the oxidant through the stack. When the stack is in the position of use, the manifold extends along an axis that is orthogonal to a width of the plate 70.

The bipolar plate 70 comprises a first opening 61 for the inlet of a heat transfer fluid which is arranged in the first transverse edge 22.

Analogously, channels for the introduction of the heat transfer fluid are produced in the plate 70 so as to allow the introduction of the heat transfer fluid from the first opening 61 into a distribution chamber arranged in the plate 70 on the first transverse edge. The distribution chamber comprises bumps or lines of solder that make it possible to promote the uniformity of distribution of the heat transfer fluid thus introduced so as to make it flow within the bipolar plate 70 in the central region 30. Advantageously, the chamber for the distribution of the heat transfer fluid may be formed by a pattern that is complementary to that applied to the chamber for the distribution of the oxidant or of the fuel. The distribution chamber extends vertically over the entire height of the central region 30.

Flow channels for the circulation of the heat transfer fluid (not shown) are arranged in the central region 30 so as to allow the fluid to circulate. These channels extend along the longitudinal axis of the plate 70 and open into a chamber for the distribution of the heat transfer fluid which is located on the second transverse edge.

The bipolar plate 70 also comprises a second opening for the collection of the heat transfer fluid 62 which is arranged in the second transverse edge 24.

Channels for the collection of the heat transfer fluid are produced in the plate 70 so as to allow the heat transfer fluid to be collected in the second opening 62 from the distribution chamber which is located on the second transverse edge. These collection channels thus make it possible to collect the heat transfer fluid that has flowed through the flow channels and has been distributed by the chamber for the distribution of the heat transfer fluid.

When the stack has been assembled, the first openings 61 for the inlet of the heat transfer fluid and the second openings 62 for the collection of the heat transfer fluid of all of the plates are superposed and form a manifold that conveys the heat transfer fluid through the stack. When the stack is in the position of use, the manifold extends along an axis that is orthogonal to a width of the plate 70.

The bipolar plate 70 comprises a fifth opening 65 for the inlet of a fuel which is arranged in the second transverse edge 24.

Analogously, channels for the introduction of the fuel are produced in the plate 70 so as to allow the introduction of the fuel from the fifth opening 65 into a chamber for the distribution of the fuel arranged in the plate 70 on the second transverse edge 24.

The chamber for the distribution of the fuel comprises bumps or lines of solder that make it possible to promote the uniformity of distribution of the fuel thus introduced so as to make it flow through the central region 30, and more particularly to make it flow through the anode electrode of the membrane electrode assembly which bears against the other face of the bipolar plate 70. The distribution chamber extends vertically over the entire height of the central region 30.

Flow channels for the circulation of the fuel are arranged in the central region 30, on the surface of the plate 70 and on the other side thereof, so as to allow the fuel to circulate. These flow channels extend along the longitudinal axis of the plate 70 and open into another chamber for the distribution of the fuel which is located on the first transverse edge 22.

The bipolar plate 70 also comprises a sixth opening 66 for the collection of the fuel which is arranged in the first transverse edge 22.

Channels for the collection of the fuel are produced in the plate 70 so as to allow the fuel to be collected in the sixth opening 66 from the distribution chamber which is located on the first transverse edge 22. These collection channels thus make it possible to collect the fuel that has flowed through the flow channels and has been distributed by the distribution chamber.

When the stack has been assembled, the fifth openings 65 for the inlet of the fuel and the sixth openings 66 for the collection of the fuel of all of the plates are superposed and form a manifold that conveys the fuel through the stack. When the stack is in the position of use, the manifold extends along an axis that is orthogonal to a width of the plate 70.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

We claim:

1. A bipolar plate for a fuel cell stack, the plate extending in a vertical plane when the fuel cell stack is in a position of use, in the vertical position of use, the bipolar plate comprising:
a first transverse edge;
a second transverse edge opposite the first transverse edge;
an upper longitudinal edge;
a lower longitudinal edge;
a central region arranged between the first transverse, second transverse, upper longitudinal, and lower longitudinal edges;
a first opening configured to receive a heat transfer fluid;
a second opening configured to collect the heat transfer fluid from the first opening;
a third opening configured to receive an inlet of a gaseous oxidant;
a fourth opening configured to collect the oxidant from the third opening;
a fifth opening configured to receive an inlet of a gaseous fuel;
a sixth opening configured to collect the fuel from the fifth opening; and
at least one distribution chamber, wherein the first, third and sixth openings are arranged in the first transverse edge and are arranged axially in relation to one another, the second, fourth and fifth openings are arranged in the second transverse edge and are arranged axially in relation to one another, and, in the vertical plane when the fuel cell stack is in the position of use:
wherein the sixth opening is arranged below the first and third openings,
wherein the fourth opening is arranged below the second and fifth openings, and
wherein the second opening is arranged above the fourth and fifth openings.

2. The bipolar plate as claimed in claim 1, wherein, in the vertical position of use of the bipolar plate, the third opening is arranged above the first and sixth openings.

3. The bipolar plate as claimed in claim 1, wherein that the distribution chamber is arranged on the first transverse edge, on a surface of the plate, the distribution chamber extending in particular at least facing the third, first and sixth openings.

4. The bipolar plate as claimed in claim 1, wherein the distribution chamber comprising protruding patterns, in particular bumps or lines of solder that are configured to promote the uniformity of distribution of a fluid.

5. The bipolar plate as claimed in claim 1, further comprising flow channels arranged in the central region.

6. The bipolar plate as claimed in claim 5, wherein the flow channels are arranged on a surface of the plate.

7. The bipolar plate as claimed in claim 6, wherein the flow channels are in the form of a corrugation of said surface.

8. The bipolar plate as claimed in claim 5, wherein the flow channels extend in the longitudinal axis of the plate.

9. The bipolar plate as claimed in claim 1, wherein each opening comprises a hole that passes through the entire thickness of the plate.

10. The bipolar plate as claimed in claim 1, wherein the arrangement of the second opening, in relation to the fourth and fifth openings, is configured to allow for natural evacuation of gas bubbles.

11. A cell for a proton exchange membrane fuel cell stack, said cell comprising two of the bipolar plates as claimed in claim 1 and a membrane electrode assembly, wherein the bipolar plates are arranged so as to cooperate together and the membrane electrode assembly is disposed between the plates.

12. A proton exchange membrane fuel cell stack, comprising at least one of the cells of claim 11.

13. The fuel cell stack of claim 12, further comprising:
an inlet manifold for a heat transfer fluid that is configured to connect to a heat transfer fluid intake to allow the heat transfer fluid to flow through the first opening,
an inlet manifold for an oxidant that is configured to connect to an oxidant intake to allow the oxidant to flow through the third opening, and
an inlet manifold for a fuel that is configured to connect to a fuel intake to allow the fuel to flow through the fifth opening.
